(19) United States
(12) Patent Application Publication
(10) Pub. No.: US 2024/0384595 A1
(43) Pub. Date: Nov. 21, 2024

(54) Ladder Arch Support Extension

(71) Applicants: Richard J. Boyington, Vero Beach, FL (US); Joseph Wyatt, Melbourne, FL (US); Julianne Wyatt, Melbourne, FL (US); Andreas Haase, Palm Bay, FL (US)

(72) Inventors: Richard J. Boyington, Vero Beach, FL (US); Joseph Wyatt, Melbourne, FL (US); Julianne Wyatt, Melbourne, FL (US); Andreas Haase, Palm Bay, FL (US)

(21) Appl. No.: 18/669,789

(22) Filed: May 21, 2024

Related U.S. Application Data
(63) Continuation-in-part of application No. 17/307,685, filed on May 4, 2021.

(51) Int. Cl. E06C 7/16

(52) U.S. Cl. CPC E06C 7/16

(57) ABSTRACT

The present invention includes a ladder step extender that when in place on a ladder extends the area where a ladder user can place his feet, providing increased stability and comfort for the user. The ladder extender comprises two hanging arms, a horizontal stepping platform, and two ladder rung holders. The extender is secured to the ladder rungs by the hanging rods placed on an upper ladder rung while the rung holders engage a lower rung. When the extender is secured to a ladder, the horizontal stepping platform extends towards the interior or toe side of the ladder and extends the area where the ladder user's foot or feet may be placed.

### CROSS REFERENCE TO RELATED APPLICATIONS

The present application is a continuation-in-part application of parent application Ser. No. 17/307,685, filed on May 4, 2021, which is incorporated herein in its entirety.

### BACKGROUND OF THE INVENTION

According to the U.S. Consumer Products Safety Commission, in 2018 more than 580,000 people in the United States were injured due to falls from ladders, resulting in at least 300 deaths. The rungs of most extension ladders sold in the United States are typically about 2 inches, or about 5 cm deep, wherein the average foot length of a North American Caucasian mail is 26.3 cm, or approximately 10.4 inches. This leads to inherent instability in the user of the ladder trying to balance on rungs that are significantly smaller than the user's feet.

Various embodiments of the present invention recognize and address the foregoing considerations, and others, of prior art devices, by providing an apparatus that may be hung on an existing ladder that will provide a larger and more stable surface for the user to stand on.

### BRIEF SUMMARY OF THE INVENTION

This Summary is provided to introduce a selection of concepts in a simplified form that are further described below in the Detailed Description. This Summary is not intended to be used to limit the scope of the claimed subject matter.

The present invention includes an accessory step extender apparatus comprised of at least two hanging arms, a horizontal stepping platform, and at least two platform support rods. In embodiments of the invention, at least two of the platform support rods are attached to the horizontal stepping platform, and at least two of the hanging rods are attached to the horizontal stepping platform directly, or the platform support rods, which themselves are attached to the horizontal stepping platform. Such apparatus is hung by the hanging rods on one rung of a ladder and by the platform support rods on a second, lower rung of the ladder. When the apparatus is hung, the horizontal stepping platform extends towards the interior of the ladder (or back if you are facing the ladder) even with or approximately even with the second rung of the ladder, thus extending the area where the ladder user's foot or feet may be placed. This extension allows for the user to not only place the ball of its foot down, but also the toe box, ball, and arch of the foot, thus providing better stability for the ladder user.

### BRIEF DESCRIPTION OF THE SEVERAL VIEWS OF THE DRAWINGS

Various embodiments of the disclosure will be described below. In the course of the description, reference will be made to the accompanying drawings, which are not necessarily drawn to scale. References to “left,” “right,” “front,” and “back” are taken from the perspective of a user facing a positioned ladder.

FIG. 1 is a right back top perspective view of a ladder accessory apparatus according to one embodiment of the present invention, in the extended position.

FIG. 2 is a right back top perspective view of the ladder accessory according to the embodiment of the invention shown in FIG. 1, in the extended position as shown positioned on a ladder (dotted lines).

FIG. 3 is a top view of the embodiment of the invention of FIG. 1 in the extended position, shown without a ladder.

FIG. 4 is a left side view of the embodiment of the invention shown in FIG. 1 in the extended position and shown without a ladder.

FIG. 5 is a back view of the embodiment of the invention shown in FIG. 1 in the extended position without a ladder.

FIG. 6 is a right side view of the embodiment of the invention shown in FIG. 1 in the extended position and shown without a ladder.

FIG. 7 is a front view of the embodiment of the invention shown in FIG. 1 in the extended position without a ladder.

FIG. 8 is a left side view of the embodiment of the invention shown in FIG. 1 shown positioned on a ladder.

FIG. 9 is a front view of the embodiment of the invention shown in FIG. 1 shown positioned on a ladder.

FIG. 10 is a top view of the embodiment of the invention shown in FIG. 1 shown positioned on a ladder.

FIG. 11 is a back view of the embodiment of the invention shown in FIG. 1 shown positioned on a ladder.

FIG. 12 is a right top perspective view of an embodiment of the invention shown with the platform folded up position and without a ladder.

FIG. 13 is a right side view of the embodiment of the invention shown in FIG. 12, in the folded position and without a ladder.

FIG. 14 is a top view of the embodiment of the invention shown in FIG. 14, in the folded position and without a ladder.

FIG. 15 is a perspective view of a ladder accessory apparatus according to a second embodiment of the present invention.

FIG. 16 is a bottom view of the platform of the second embodiment.

FIG. 17 is a perspective view of the second embodiment attached to a ladder.

FIG. 18 is a side view of an arm and platform of the second embodiment.

FIG. 19 is a close-up view of a second embodiment of a rung holder.

### DETAILED DESCRIPTION OF THE PREFERRED EMBODIMENTS OF THE INVENTION

Various embodiments will now be described more fully hereinafter with reference to the accompanying drawings. It should be understood that the concepts disclosed herein may be embodied in many different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout.

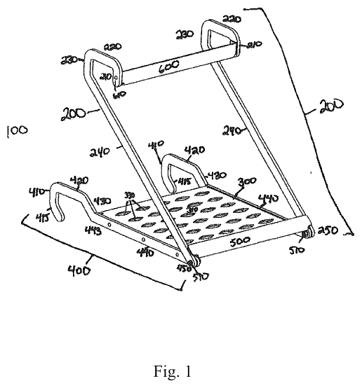

Referring now to FIGS. 1-14, aspects of the ladder accessory step extender apparatus 100 will be discussed in detail. According to various embodiments, the accessory step extender apparatus 100 includes at least two hanging arms 200, a horizontal stepping platform 300, and at least two platform support rods 400. At least two of the platform support rods 400 are attached to the horizontal stepping platform 300, and at least two of the hanging rods are attached to the horizontal stepping platform 300 directly, or the platform support rods 400, which themselves are attached to the horizontal stepping platform.

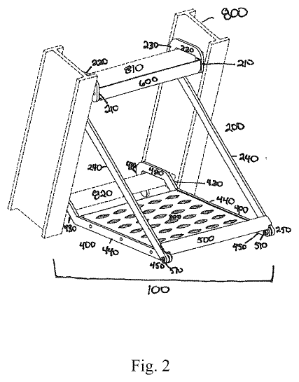

As shown in the embodiment in FIGS. 1-2 each of the at least two hanging arms 200 is comprised of a vertical interior extension 210 which connects to an arm horizontal step overlay 220 which connects to a vertical exterior extension 230, and which connects to a diagonal hanging extension 240. At the opposite end from the connection to the vertical extender extension 230 the diagonal hanging extension 240 terminates at its platform attachment end 250 of the hanging arm 200. In the embodiments shown in FIGS. 1-14, each of the vertical interior extension 210, arm horizontal step overlay extension 220, vertical exterior extension 230, and diagonal hanging extension 240 are parts of a unitary piece, which is bent to form the particular extension. However, in other embodiments, one or more of these may be separate components which are connected to each other using various connection methods, such as various types of welding, rivets, screws, bolts, molded inserts, bonding, and other means of connection. In preferred embodiments, each hanging arm is a unitary molded or bent piece.

The invention is further comprised of a horizontal stepping platform 300. The horizontal stepping platform 300, when the apparatus is engaged, is intended to bear the weight of the user's foot or feet, either entirely or in addition to the rung 820 on which the platform support rods 400 are hung. The horizontal stepping platform 300 in the embodiment shown in FIGS. 1-11 is of rectangular shape, but in other embodiments, it may be of other shapes, including but not limited to square, hexagonal, semioval, and other appropriate shapes. As shown in FIGS. 1-2, the horizontal stepping platform 300 is comprised of a top stepping surface 310, and a bottom surface 350. As shown in the embodiments in FIGS. 1-14, the horizontal stepping platform may optionally include multiple holes 330, which may be pierced, bored, punched, molded, or included through other methods. Such holes 330 may include hole extensions that may extend beyond the bottom surface 350 of the horizontal stepping platform. Such holes 330 may aid in drainage of liquids on the top stepping surface 310 of the horizontal stepping platform and/or may aid in traction with the user's shoes or feet.

As shown in FIG. 1 and other Figures, embodiments of the invention are further comprised of two or more platform support rods 400. The embodiments shown in the Figures have two platform support rods 400, with one platform support rod attached to each of the two sides of the horizontal stepping platform 300.

When there are two platform support rods 400, each platform support rod is comprised of at least a horizontal platform side support 440, a rod interior extension 430, a rod horizontal step overlay 420, and a rod exterior vertical extension 410. Each horizontal platform side support 440 is comprised of an arm attachment end 450 and a step end 443 In each of the two platform support rods 400, the rod interior extension 430 connects to or extends from the step end 443 of the horizontal platform side support 440. In the embodiment shown in FIGS. 1-2, the two platform support rods 400 are further comprised of a rung under support 415, which in this embodiment extends from the end of the exterior vertical extension 410 and is angled diagonal from to extend to a certain extent under the rung on which the platform support rod 400 hangs.

One of each of the two platform rods 400 is either attached to (as shown in FIG. 1) or integrated with each outer side 360, 370 of the horizontal stepping platform 300 at the horizontal platform side support 440. Such attachment of the horizontal platform side support 440 to the outer side 360 or 370 of the horizontal stepping platform 300 may be by any reasonable attachment or connection methods, including but not limited such as various types of welding, rivets, screws, bolts, molded inserts, bonding, and other means of connection. In a preferred embodiment, as shown in FIGS. 1-2, each horizontal side support is riveted to an outer side of the horizontal stepping platform 300.

As shown in FIG. 1, each of the two side platform support rods 400 is attached to a respective hanging arm 200 at the platform attachment end 250 of the hanging arm 200 and the arm extension end 450 of the platform support rod 400. Such attachment may be through a static means of attachment, including but not limited to welding, rivets, thermal attachments, and the like. In preferred embodiments, such as those shown at least in FIGS. 1-2, and 12-14, the platform attachment end 250 and the arm extension end 450 are connected using a means that allows for movement 510, so that the hanging arms 200 may be moved into various positions with respect to the horizontal stepping platform 300. Such means may include using threaded rods with lock nuts, screw, rivets, threaded bolts with nuts and washers, and other similar mechanisms.

In preferred embodiments, which will be further explained in relation to FIGS. 1-14 below, the two hanging arms 200 may be folded down such that in the folded position the diagonal hanging extension 240 of each hanging arm rests next to the respective corresponding horizontal platform side support 440 of the two platform support rods 400.

The ladder 800 is not a part of the embodiment of the apparatus 100 itself, but for the purpose of illustrating how the apparatus is used in conjunction with a ladder, various components of the ladder are described herein as well. When referring to the interior end of a rung of a ladder, we are herein referring to the long edge of the rung that, in ordinary use, the ladder climber's toe would be closest to. When referring to the exterior end of a rung of a ladder, we are herein referring to the long edge of the rung that, in ordinary use, the ladder climber's heel would be closest to.

As shown in FIG. 2, when the apparatus is shown as applied to an extension ladder, the hanging arms 200 of the apparatus are hung on a first rung 810 of the ladder 800. When the apparatus 100 is used on a ladder 800, the arm horizontal step overlay extension 220 of each hanging arm 200 rests on top of the first rung 810 of the ladder. The vertical interior extension 210 rests along or near the interior end of the first rung 810. The vertical exterior extension 230 rests along or near the exterior end of the first rung 810.

As further shown in FIG. 2, when the apparatus 100 is used with a ladder 800, the rod horizontal step overlay 420 of each side platform support rod 400 rests on top of the second rung 820 of the ladder. At least a portion of each rod interior extension 430 rests at or near the interior end of the second rung 820 of the ladder. Each rod exterior vertical extension 410 rests at or near the exterior end of the second rung 820 of the ladder.

In the embodiment shown in FIG. 2, the optional rung under support 415, which extends from the rod exterior vertical extension 410 extends down below at least part of the second rung. This optional rung under support 415 can provide positional protection on the ladder against an upward force, such as a shoe or foot sticking to the horizontal stepping platform 300 and lifting the apparatus off of the ladder when such is not intended.

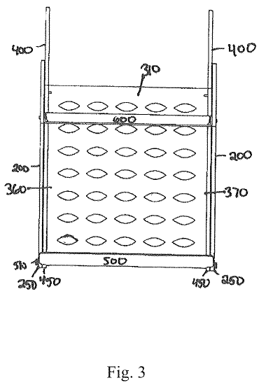

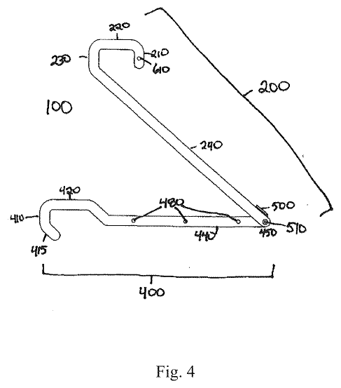

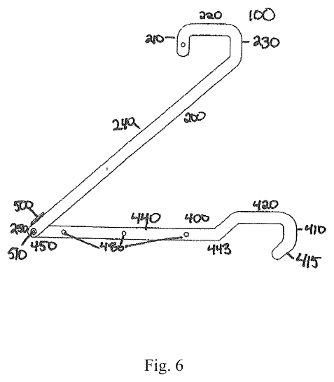

FIG. 3 shows a top view of the embodiment of the invention shown in FIG. 1 when extended but not positioned on a ladder. FIG. 4 illustrates a side view of the embodiment of the invention shown in FIG. 1 as extended but not applied to a ladder, and the other side view of the same embodiment is illustrated in FIG. 6.

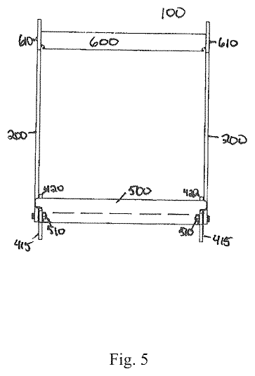

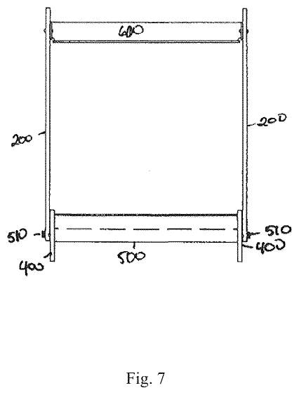

FIG. 5 is a back view of the embodiment of the invention shown in FIG. 1 in the extended position without a ladder. FIG. 7 is a front view of the embodiment of the invention shown in FIG. 1 in the extended position without a ladder.

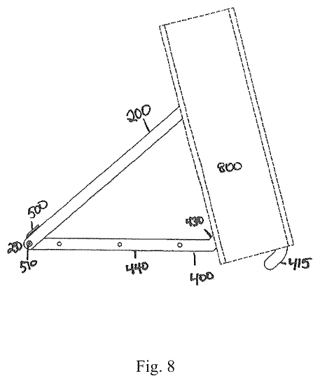

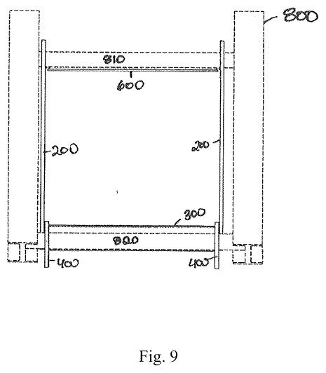

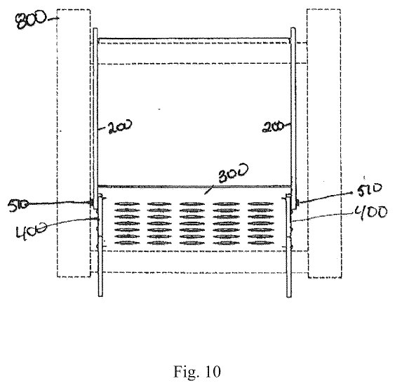

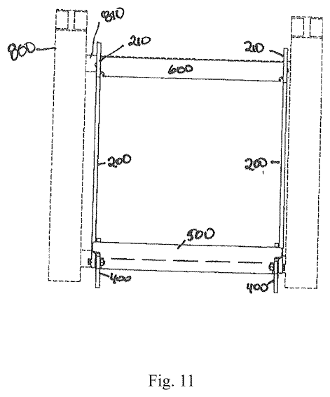

FIG. 8 is a left side view of the embodiment of the invention shown in FIG. 1 shown positioned on an extension ladder. FIG. 9 is a front view of the embodiment of the invention shown in FIG. 1 shown positioned on a ladder. FIG. 10 is a top view of the embodiment of the invention shown in FIG. 1 shown positioned on a ladder. FIG. 11 is a back view of the embodiment of the invention shown in FIG. 1 shown positioned on a ladder.

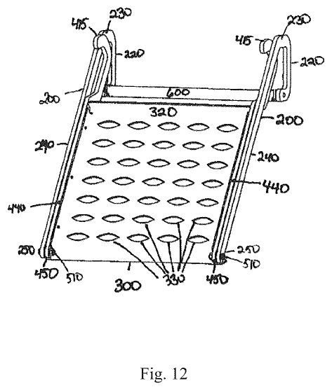

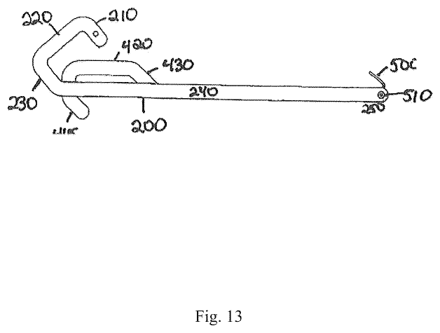

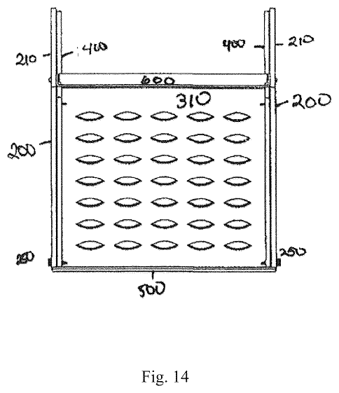

FIG. 12 is a right top perspective view of an embodiment of the invention shown with the platform folded up position and without a ladder. FIG. 13 is a right side view of the embodiment of the invention shown in FIG. 12, in the folded position and without a ladder. FIG. 14 is a top view of the embodiment of the invention shown in FIG. 14, in the folded position and without a ladder.

In the embodiments shown in FIGS. 1-14, the apparatus is further comprised of a first rung lateral support 600 which extends between the respective vertical interior extensions 210 of each of the two side hanging arms 200. The first rung lateral support can serve as a handle when the user is carrying an apparatus prior to applying it to a ladder. Such lateral support may an integrated part between the respective vertical interior extensions, and if the apparatus constructed using a molding technique, it may be molded as a unitary part with the two side hanging arms. In preferred embodiments, the two side hanging arms 200 and the first rung lateral support 600 are a unitary piece made from injection-molded fiberglass. If it is not manufactured as a unitary part with the side hanging arms 200, then the first rung lateral support 600 may be attached to the respective side hanging arms 200 using any known attachment mechanism, including but not limited to threaded bolts, rivets, welding, screws, molded inserts, bonding, and thermal attachment. As shown the lateral support 600 is attached to the respective vertical interior extensions using rivets.

In the embodiments shown in FIGS. 1-14, the apparatus is further comprised of an optional arm stepping platform lateral stop 500 which extends between the two respective diagonal hanging extensions 240 near the platform attachment end 250 of each of the two side hanging arms 200. In this embodiment, such arm stepping platform lateral stop 500 is positioned such that it is near the interior or user's toe end of the horizontal stepping platform 300 and on the side of the horizontal stepping platform opposite the second rung 820. In embodiments that fold to a closed position, such as shown in FIG. 13, the arm stepping platform lateral stop can act as a stop so that when extending the apparatus, it does not extend past a desirable angle, to the fully vertical position, or flip over itself. In embodiments for folding apparatuses that include the optional arm stepping platform lateral stop 500, it is positioned such that the maximum extension angle between the respective corresponding platform support rods 400 and hanging arms 200 is less than 70 degrees, more preferably less than or equal to 60 degrees, even more preferable less than 55 degrees, and in most uses and most preferable less than or equal to 50 degrees. Other components other than the shown arm stepping platform lateral stop 500 may alternately optionally be used to prevent overextension in embodiments that are capable of being folded, including but not limited to using one or more flexible straps that connect the corresponding platform support rods to the corresponding hanging arms, as well as mechanical limits put on the folding mechanism 510.

As referenced above, in a preferred embodiment of the invention, the platform attachment end 250 and the arm extension end 450 are connected using a means that allows for movement, so that the hanging arms 200 may be moved into various positions with respect to the horizontal stepping platform 300. FIGS. 12-14 illustrate an apparatus according to one such embodiment of the invention, whereas the horizontal stepping platform 300 is fully folded when not in use, such that the diagonal hanging extensions 240 of the hanging arms 200 are fully folded so that they are next to and run along the horizontal platform side supports 440 of the side platform support rods 400, and the bottom surface 320 of the horizontal stepping platform 300 is shown. Folding this and similar embodiments of the invention in this manner will allow both for easy carrying and compact storage of the apparatus when not in use.

In some optional embodiments of the invention, the two side platform support rods 400 may each be integrated with in a unitary piece with the horizontal stepping platform 300, such that the horizontal side supports 440 of each side platform support rod is each outer side 360, 370 of the horizontal stepping platform 300.

In other embodiments of the invention, additional platform support rods (in addition to the two on the sides of the horizontal stepping platform) may be included and attached to the bottom surface 350 of the horizontal stepping platform 300 to provide more support. Such additional platform support rods may be comprised of all of the components described herein, or may be comprised of fewer than all of the components described herein. In one embodiment of the invention, at least a third platform support rod is attached to the bottom surface 350 of the horizontal stepping platform. Further embodiments which are not shown in the Figures may include additional platform supports, which may optionally extend horizontally across the bottom surface 350 of the platform support rod, i.e. from the first outer side 360 to the second outer side 370.

In other embodiments of the invention not shown in the drawings, the horizontal stepping platform 300 may not include any holes. The top stepping surface 310 horizontal stepping platform 300 may optionally be a smooth surface with no holes or indentations. The top stepping surface 310 of the horizontal stepping platform 300 may also optionally include one or more other tractional features, including but not limited to nubs, ridges, grooves, spikes, indentations, or other features to improve the traction of the user's feet on the top surface 310 of the horizontal stepping platform.

The optional holes 330 of the horizontal stepping platform 330 may, as shown in the Figures be eye-shaped. However, such optional holes may have other alternative shapes, including but not limited to round, oval oblong, triangular, square, rectangular, pentagonal, hexagonal, or other regular polygon or irregular shapes.

In apparatuses according to the invention, the respective lengths of the arms 200 and side platform support rods 400 are such that the arms and the side platform support rods 400 may be hung on successive rungs of a ladder when the embodiment of the invention is it its extended position. In preferred embodiments, the length of the diagonal hanging extensions 240 is 13.5 to 14.5 inches, preferably 14 inches. The preferred total length of each hanging arm 200 is 15.5 inches to 16.5 inches in total length, more preferably about 16 inches, and most preferably 16 inches.

In preferred embodiments of the invention, the arm horizontal step overlay extension 220 and rod horizontal step overlay 420 each have a respective length such that the apparatus may be used on most movable standard step ladders, extension ladders, and pylon ladders. However, this statement is not meant to limit embodiments of the invention for use only with such ladders or devices.

The respective distance between the two hanging arms 200 with respect to each other and the distance between each of the respective side platform support rods 400 with respect to each other must be such that the apparatus in accordance with the invention fits between the side vertical supports of a ladder, and onto the rungs themselves. Thus, the apparatus in accordance with the invention must be narrower than the ladder such apparatus is used on. In preferred embodiments of the invention, the interior distance between the respective hanging arms is between 12⅜ inches and 12⅝ inches, more preferably about 12½ inches. Similarly, the preferred width of the horizontal stepping platform 300 is 12.5 inches.

The horizontal stepping platform 300 should be of sufficient size to effectively extend the second rung 820 of the ladder so that more of a user's foot may be placed on the 300 than is typically placed on a rung of a ladder. The horizontal stepping platform is preferably of sufficient size such that an adult's entire toe box, ball of foot portion of the shoe, and part of the arch area of the user's shoe will fit well within the platform, if used by an adult. As shown in the embodiments in the figures and as described in this paragraph, an adult male user with a US size 14 shoe could place his foot on the extension device and it would still make for a comfortable step that supports not only the ball of the foot, but the toe and arch portion as well. In preferred embodiments, the depth of the horizontal stepping platform as measured from the arm attachment end 450 to the step end 443 is between 8 and 11 inches, more preferably between 9 and 10 inches, most preferably 9.5 inches. The thickness of the horizontal stepping platform should maintain a balance between thinness, for ease of use, and mechanical support to enable support of any reasonable adult user's weight. It should be of appropriate materials and thickness to be able to support at least a 250 pound person, more preferably at least 300 pounds. The horizontal stepping platform 300 may be made of any variety of rigid materials, including steel, fiberglass, other metals, and rigid formed plastic. In preferred embodiments, the horizontal stepping platform 300 is composed of ½ inch honeycomb fiberglass.

In preferred embodiments of the invention, the angles of vertical interior extension 210, arm horizontal step overlay extension 220, vertical exterior extension 230, diagonal hanging extension 240 with respect to each other are such that and the angles of the rod interior extension 430, the rod horizontal step overlay 420, and rod exterior vertical extension 410 with respect to each other are such that when the apparatus is positioned on the ladder 800, the platform 300 is even with the second rung 820 or parallel to the ground, or both. This may be accomplished with both rounded shapes of vertical interior extension 210 and vertical exterior extension 230 and more squared-off shapes. In preferred embodiments, the angle between the vertical interior extension 210 and horizontal step overlay extension on a hanging arm 200 and the arm horizontal step overlay extension 220 is 85 to 95 degrees, more preferably about 90 degrees. In preferred embodiments, the angle between the arm horizontal step overlay extension 220 and vertical exterior extension 230 is 85 to 95 degrees, more preferably about 90 degrees. In preferred embodiments, the angle between vertical exterior extension 230 and diagonal hanging extension 240 is between 120 and 130 degrees, more preferably about 130 degrees. In embodiments of the invention with two hanging arms 200, both hanging arms should be of similar or identical dimensions and with similar or identical angles.

In preferred embodiments of the invention, the length of each rod horizontal step overlay 420 is between 1⅞ inches and 2⅜ inches, more preferably 2 to 2¼ inches, most preferably 2¼ inches. In preferred embodiments of the invention, the length of each arm horizontal step overlay extension 220 is between 1⅞ inches and 2⅜ inches, more preferably 2 to 2¼ inches, most preferably 2¼ inches.

The various components of embodiments of the apparatus according to the invention may be made of different materials that possess the necessary strength and rigidity to support at least 250 pounds of weight. Thus, in preferred embodiments of the invention, the hanging arms 200, horizontal stepping platform 300, and side platform support rods 400 are made of aluminum, steel, reinforced polyester resin, and/or fiberglass, more preferably aluminum or fiberglass, most preferably fiberglass.

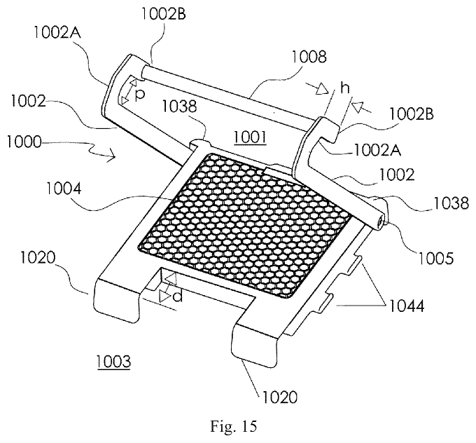

FIGS. 15-19 illustrate another embodiment of a ladder step extender 1000 (commercially referred to as a NYLOTREAD ladder arch support) according to the teachings of the present invention.

When the ladder step extender is disposed on a ladder, a region 1001 is generally referred to as an inward, interior, or toe region. While a region 1003 is generally referred to as an outward, exterior, or heel region.

FIG. 15 depicts two spaced-apart arms 1002 rotatably attached to and extending upwardly from a toe region of platform 1004. Reference numeral 1005 identifies a rotatable joint for rotation for the arms 1002 relative to the platform 1004. In one embodiment, the rotatable joint is formed by a metal-threaded insert on each side surface of the platform. The threaded inserts are applied using ultrasonic welding or thermal insertion. A fastener (e.g., a threaded bolt) passes through a through-hole in each arm for receiving within one of the threaded inserts. A high-strength thread-locking compound secures the fastener within the threaded insert.

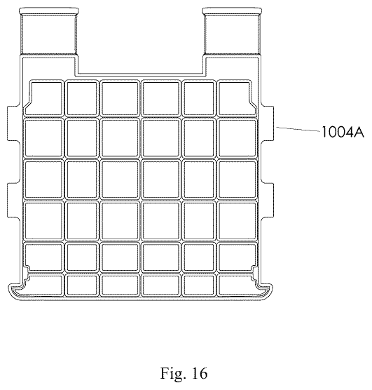

A bottom surface 1004A of the platform 1004 comprises a walled construction with cross-sectional members to add torsional rigidness and strength. See FIG. 16.

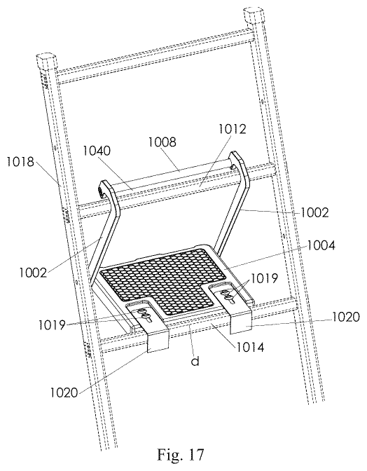

A shape of the upper ends of each arm 1002 is non-linear such that a ladder rung is received within a region 1002A of each arm. See FIG. 15. FIG. 17 illustrates the ladder step extender 1000 in use on two consecutive rungs 1012 and 1014 of a ladder 1018.

In one embodiment each arm 1002 features cross-bracing and I-beam construction that provides additional support for the injection-molded fiberglass-filled nylon material that comprises the arms. This construction structure increases the weight-carry capacity of the ladder step extender.

Free ends 1002B of the two arms 1002 are connected by a cross bar 1008. A material of the cross bar comprises aluminum, glass-filled nylon, or any material that can withstand the forces exerted on the bar when the platform is in use. In one embodiment each end of the cross bar is attached to an arm 1002 with a fastener (a threaded bolt, for example) that passes through a through-hole in each arm into a mating opening in each end of the bar.

Referring to FIG. 15, two L-shaped rung holders 1020 extend from a rear surface of the platform 1004. When the ladder step extender is in use, the brackets are positioned over a ladder rung 1014, as illustrated in FIG. 17.

The brackets can be formed integral with the platform 1004 (as illustrated in FIG. 15) or can be fabricated as separate components and attached to the platform using any well-known hardware components 1019, as illustrated in FIG. 17.

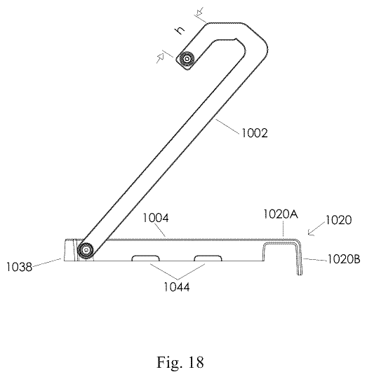

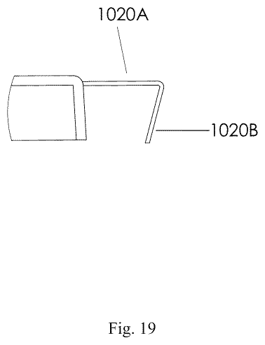

FIGS. 18 and 19 illustrate two different configurations for the rung holders 1020. In FIG. 18, a vertical segment 1020B of the rung holder forms an angle of about 90 degrees with a horizontal segment 1020A of the rung holder. In FIG. 19, the vertical segment 1020C forms an angle of less than 90 degrees with the horizontal segment 1020A. This latter embodiment provides an improved wedge-gripping action of the rung holder on the ladder rung, and thus improved gripping of the platform on the ladder rung. In either case, the rung holders are designed to set flat on a D-shaped ladder rung, which has a flat top surface. The rungs 1012 and 1014 have such a flat surface as illustrated in FIG. 17.

The rung holders 1020 are designed to fit ladder rungs having a width of about 1¾ inches. Preferably, the ladder step extender of the invention is intended for attachment to the upper segment of an extension ladder. Generally, the invention can be used with any ladder rung to offer comfort and ease stress on the user's feet while providing sufficient and safe stability.

The rung holders 1020 feature a nylon-based multi rib design on a lower surface. When the user stands on the step extender, the nylon material provides sufficient friction between the rung holders and the rung to hold the step extender steadily in place without movement. The multiple ribs on the bottom surface also provide structural strength.

As depicted in FIG. 17, in one embodiment, a distance “d” is established to define an opening 1030 between the ladder rung 1014 and the platform 1004. This opening allows the user to grip the ladder rung 1014 as he ascends or descends the ladder when the ladder step extender 1000 is in place on a ladder.

Note also that the rung holders 1020 as depicted in FIG. 15 are molded with the platform 1004, while in FIG. 17 the rung holders are depicted as separate components that are attached to the platform. Both embodiments are considered within the scope of the present invention. In either case, the distance “d” defined to form the opening and is generally between about ¾″ and 2 inches.

With reference to FIG. 18, the platform 1004 comprises an arm stop 1038 on each side surface of the platform 1004, for preventing the arms from rotating counter-clockwise below the platform and thereby preventing placement of the ladder, and thereby the step extender, at an unsafe angle.

A distance “p” in FIG. 15 is established to provide a gap (between the cross bar 1008 and the ladder rung) of sufficient width to allow the user to grip an upper ladder rung as she climbs or descends the ladder. The gap is identified by reference character 1040 in FIG. 17. Creating this gap requires extending the terminal end of each arm 1002, which has the advantageous effect of lowering the risk that the user will dislodge the ladder step extender from the ladder rungs as she climbs or descends the ladder. In one embodiment the distance “p” is between about 1.5 and 2.5 inches. The distance “n” in FIG. 15, (see also FIG. 18) which also effects the gap size, identifies the length of the terminal end of each arm and is between about 2 inches and 4 inches.

With reference to FIG. 15, the platform includes one or more tabs or arm stops 1044 on each side surface of the platform 1004. In FIG. 15, two tabs 1044 are shown on a side surface 1004A with two additional tabs 1044 not visible on the opposing hidden surface of the platform. The tabs prevent clockwise rotation of the two arms 1002 below the platform. This feature allows for compact storage and convenient carrying of the ladder step extender 1000.

In one embodiment, a top surface of the platform 1004 comprises a non-slip surface further comprising a molded-in etched rough surface that provides some resistance between the user's footwear and the platform.

What is claimed is:

1. A ladder step extender for attachment to an upper and a lower rung of a ladder, the ladder step extender comprising:
a platform bounded by a first side surface, a second side surface, an interior-facing toe surface, and an exterior-facing heel surface, the platform extending inwardly of the ladder when the ladder step extender is attached to the ladder;
a first and a second arm, each comprising:
a linear segment having a first end rotatably attached to a respective first and second side surface of the platform proximate the interior-facing toe surface; and
a non-linear hanging segment for receiving an upper ladder rung within the non-linear hanging segment;
a cross bar disposed between and connected to the non-linear hanging segment of each one of the first and second arms;
a first gap defined between the cross bar and an upper rung when the ladder step extender is attached to a ladder;
first and second spaced-apart rung holders extending from the exterior-facing heel surface of the platform, a lower rung received within the first and second spaced-apart rung holders;
a second gap defined between a lower rung and the exterior-facing heel surface of the platform when the ladder step extender is attached to a ladder;
first and second arm stops extending from respective side surfaces of the platform for preventing rotation of the first and second arms in a counter-clockwise direction beyond the first and second arm stops; and
third and fourth arm stops extending from respective side surfaces of the platform proximate the interior-facing toe surface, for limiting rotation of the first and second arms in a clockwise direction beyond the third and fourth arm stops.

2. The ladder step extender of claim 1, wherein a top surface of the platform comprises a non-slip surface.

3. The ladder step extender of claim 2, wherein the non-slip surface comprises a molded-in etched surface.

4. The ladder step extender of claim 1, wherein a material of the first and second rung holders comprises nylon.

5. The ladder step extender of claim 1, wherein a bottom surface of the platform comprises a grid-like structure.

6. The ladder step extender of claim 1, wherein each one of the first and second rung holders comprises a planar horizontal segment forming an angle of less than 90 degrees with a planar vertical segment.

7. The ladder step extender of claim 1, wherein each one of the first and second rung holders comprises a planar horizontal segment forming an angle of 90 degrees with a planar vertical segment.

8. The ladder step extender of claim 1, wherein a distance between the first and second arms is between 10 and 12 inches.

9. The ladder step extender of claim 1, wherein a length of each one of the first and second arms is between 15 and 17 inches.

10. The ladder step extender of claim 1, wherein a distance between a heel-side edge of the platform to a toe side edge of the platform is between 12 inches and 15 inches.

11. The ladder step extender of claim 1, wherein a ladder has a plurality of ladder rungs each ladder rung defining a flat rung foot surface, wherein the non-linear hanging segment of each one of the first and second arms comprises a planar surface for placing in contact with a flat rung foot surface of a ladder rung.

12. The ladder step extender of claim 1, wherein a distance between a heel end of the platform and the vertical segment of each one of the rung holders is adjustable.

13. The ladder step extender of claim 1, wherein the non-linear segment of each one of the first and second arms extends beyond a point of connection with the cross bar by between 2 and 4 inches.

14. The ladder step extender of claim 1, wherein each rotatable joint between each one of the first and second arms and the platform comprises a metal-threaded insert joined to the platform using an ultrasonic welding technique, and a fastener disposed in an opening in each one of the first and second arms and received within the metal-threaded insert, and further comprising a thread-locking compound disposed within the metal-threaded insert.
